(19) United States
(12) Patent Application Publication
(10) Pub. No.: US 2012/0076598 A1
(43) Pub. Date: Mar. 29, 2012

(54) MILLING MACHINE FOR PRODUCING TOOTHED WHEELS

(75) Inventors: Günter Bender, Heidenrod (DE); Uwe Göbel, Hohenstein (DE); Wolfgang Horn, Goppingen (DE)

(73) Assignee: MAG IAS GMBH, Goppingen (DE)

(21) Appl. No.: 13/245,107

(22) Filed: Sep. 26, 2011

(30) Foreign Application Priority Data
Sep. 27, 2010 (DE) 102010041481.6

(51) Int. Cl. B23F 5/20

(52) U.S. Cl. 409/55

(57) ABSTRACT

A milling machine for producing toothed wheels has a workpiece receiver for receiving a workpiece to be toothed, which workpiece receiver can be pivoted relative to a machine frame about a workpiece pivot axis. To produce the tooth system, two machining units with two tool spindles are provided to receive milling tools. A first tool spindle can be moved linearly relative to the workpiece receiver in at least two directions and can be pivoted about a spindle pivot axis, which runs parallel to the workpiece pivot axis. A second tool spindle can be moved linearly relative to the workpiece receiver in at least two directions. The milling machine has high manufacturing productivity and flexibility and, in particular, also allows the production of tooth systems with an uneven number of teeth.

### CROSS-REFERENCES TO RELATED APPLICATIONS

This application claims the priority of German patent application, Serial No. 10 2010 041 481.6, filed Sep. 27, 2010, pursuant to 35 U.S.C. 119(a)-(d), the content of which is incorporated herein by reference in its entirety as if fully set forth herein.

### FIELD OF THE INVENTION

The invention relates to a milling machine for producing toothed wheels.

### BACKGROUND OF THE INVENTION

Milling machines for producing toothed wheels are basically known. The drawback in these milling machines is that their manufacturing productivity and flexibility is limited and, in particular, is felt to be inadequate by the customers.

A modular-construction milling machine for the material-removing machining of gear wheels is known from DE 43 28 801 A1. A working spindle with a vertical rotary axis and three machining units are arranged on a lower machine-tool framework. The machining units are configured such that fly cutters have to be used as milling tools.

### SUMMARY OF THE INVENTION

The invention is based on an object of providing a milling machine for producing toothed wheels, which, in a simple manner, has high manufacturing productivity and flexibility.

This object is achieved by a milling machine for producing toothed wheels with a machine frame, a workpiece receiver for receiving a workpiece to be toothed, which workpiece receiver, is arranged on the machine frame and is pivotable about a workpiece pivot axis, a first machining unit for producing a tooth system on the workpiece, wherein the latter has a first tool spindle to receive a milling tool, the first tool spindle is movable linearly relative to the workpiece receiver in at least two directions, and the first tool spindle is pivotable about a first spindle pivot axis, which runs parallel to the workpiece pivot axis, a second machining unit for producing the tooth system on the workpiece, wherein the latter has a second tool spindle to receive a milling tool, and the second tool spindle is movable linearly relative to the workpiece receiver in at least two directions.

The milling machine according to the invention has two machining units, which are arranged substantially opposing relative to the workpiece receiver and simultaneously machine the workpiece to be toothed. The tool spindles of the machining units can be moved linearly relative to the workpiece receiver in at least two directions, in each case, so that at least two linear axes are provided for each of the tool spindles and are used to feed the milling tools and to tooth the workpiece. A high manufacturing productivity of the milling machine is ensured by the two machining units. The tool spindle of the first machining unit can additionally be pivoted about a first spindle pivot axis, which runs parallel to the workpiece pivot axis of the workpiece receiver. The first spindle pivot axis is unpivotable relative to the workpiece spindle axis. Preferably, only the first machining unit comprises the first spindle pivot axis. The second machining unit or other machining units preferably do not have a corresponding spindle pivot axis. As a result, the assembly of the milling machine remains simple. By the first spindle pivot axis both toothed wheels with an even number of teeth and toothed wheels with an uneven number of teeth can be produced, whereby high manufacturing flexibility is provided. To produce toothed wheels with an uneven number of teeth, the tool spindle is pivoted about the first spindle pivot axis, so the workpiece to be toothed can simultaneously be machined by means of the two tool spindles or machining units. The milling machine, in particular, also allows obliquely running tooth systems to be produced in that the workpiece is pivoted about the workpiece pivot axis during machining and the tool spindles are accordingly synchronously linearly moved. Furthermore, the milling machine allows tooth systems to be produced with straight or curved tooth flanks. Since the milling machine according to the invention has a total of at least four linear axes and two pivot axes, high manufacturing productivity and flexibility is provided as the most varied tooth systems can be produced simultaneously with two machining units. The milling machine is preferably configured as a vertical milling machine. The milling machine is preferably a turning and milling machine, by means of which turning and milling machining of the workpiece is made possible. In particular, the milling machine is configured as a vertical turning machine and vertical milling machine. The milling tools are preferably configured as face cutters and/or peripheral milling cutters.

A milling machine, in which the first tool spindle has a first tool receiver for the milling tool, which tool receiver is rotatably drivable by means of a first spindle drive motor about a first spindle rotational axis, the second tool spindle has a second tool receiver for the milling tool, which tool receiver is rotatably drivable by means of a second spindle drive motor about a second spindle rotational axis, and the spindle rotational axes, to produce the tooth system, enclose an angle α, which does not equal 180°, wherein the angle α is, in particular, located in a horizontal plane, in a simple manner, allows the production of toothed wheels with an uneven number of teeth. Since the first tool spindle can be pivoted about the first spindle pivot axis, the spindle rotational axes of the tool spindles enclose an angle α, which does not equal 180°. As a result, the workpiece can be machined simultaneously with the two tool spindles to produce the tooth system. The pivotability of the first tool spindle about the first spindle pivot axis and the corresponding positioning of the spindle rotational axes therefore ensure that the milling tools can be positioned relative to the workpiece to be machined so that a tooth gap of a tooth system with an uneven number of teeth can be produced simultaneously by means of the two tool spindles.

A milling machine, in which the spindle rotational axes, to produce the tooth system, in each case run perpendicular to the workpiece pivot axis and intersect the workpiece pivot axis, the workpiece pivot axis in particular running in a vertical z direction, ensures simple and precise production of the tooth system, as the two spindle rotational axes have a mutually corresponding orientation with respect to the workpiece pivot axis.

A milling machine, in which the tool spindles are movable linearly relative to the workpiece receiver in at least three directions, in each case, increases the manufacturing productivity and flexibility. Since the two tool spindles can be moved linearly relative to the workpiece receiver in at least three directions, in each case, toothed wheels with different diameters can be easily produced, for example. Owing to the total of six linear axes, the feeding of the milling tools and the machining of the workpieces is simplified, as additional movement possibilities are available.

A milling machine, in which at least one of the tool spindles, in particular each of the tool spindles, is pivotable about a second spindle pivot axis, which runs perpendicular to the workpiece pivot axis, increases the manufacturing productivity and flexibility as the most varied machining steps, such as, for example, grinding, drilling or tapping, milling, rough turning or final turning are possible by flexible setting of the corresponding tools. The milling machine according to the invention therefore preferably has a total of six linear axes and four pivot axes, whereby an extremely high manufacturing productivity and flexibility is achieved.

A milling machine, in which x-guide rails running in a horizontal x-direction are arranged on the machine frame, and the machining units is movable linearly in the x-direction by means of a respective x-drive motor, or in which the machine frame is configured in the manner of a stand and the x-guide rails are arranged spaced apart from one another in a vertical z-direction on the machine frame, in a simple manner, allows the configuration of two x-linear axes. The machining units are preferably mounted on common x-guide rails which are arranged on a common support section in the form of a stand.

A milling machine, in which each of the machining units comprises an x-slide, which is movable on the x-guide rails, z-guide rails, which are arranged on the x-slide and run in a vertical z-direction, and a z-slide, which is movable linearly on the z-guide rails by means of a z-drive motor, in a simple manner, allows the configuration of two z-linear axes.

A milling machine, in which each of the machining units comprises a support part projecting in a horizontal y-direction and arranged on the z-slide, y-guide rails running in the y-direction and arranged on the support part, and a y-slide, which is movable linearly on the y-guide rails by means of a y-drive motor, or in which the y-guide rails are spaced apart from one another in the x-direction and the respective y-slide is arranged hanging on the associated support part, in a simple manner, allows the configuration of two y-linear axes.

A milling machine, in which the tool spindles are arranged on the respective y-slide and, in particular, the spindle rotational axis of the second tool spindles is arranged parallel to the x-direction, in a simple manner, allows a linear displaceability of the respective tool spindles along the associated x-, y- and z-linear axis.

A milling machine, in which at least one of the tool spindles, in particular each of the tool spindles, is arranged by means of a spindle holder on the associated y-slide, the at least one tool spindle being pivotable by means of a b-drive motor about the second spindle pivot axis, in a simple manner, allows the configuration of a respective b-pivot axis.

A milling machine, in which the first tool spindle is arranged on the associated y-slide so as to be pivotable by means of a c-drive motor about the first spindle pivot axis, in a simple manner, allows the configuration of a c-pivot axis of the first tool spindle.

A milling machine, in which the workpiece receiver is pivotable without play about the workpiece pivot axis by means of two c-drive motors, ensures a high production precision, as the c-pivot axis of the workpiece receiver or the tool pivot axis is substantially play-free.

A milling machine, in which the first spindle pivot axis runs spaced apart from the workpiece pivot axis, ensures a high manufacturing productivity. By the first spindle pivot axis being spaced apart in a radial direction from the workpiece pivot axis only small masses have to be pivoted along short distances for pivoting the work spindle of the first machining unit. This ensures a high machining velocity and low downtimes thus ensuring a high manufacturing productivity.

Further features, advantages and details of the invention emerge from the following description of an embodiment.

### BRIEF DESCRIPTION OF THE DRAWINGS

FIG. 1 shows a perspective view of a milling machine for producing toothed wheels with two machining units,

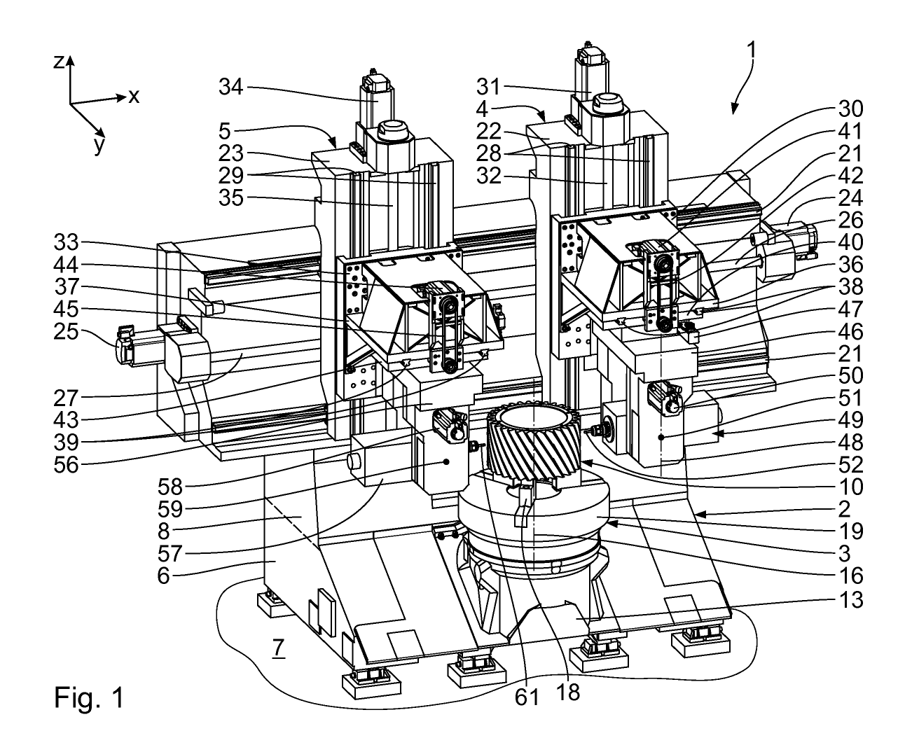

FIG. 2 shows a front view of the milling machine in FIG. 1,

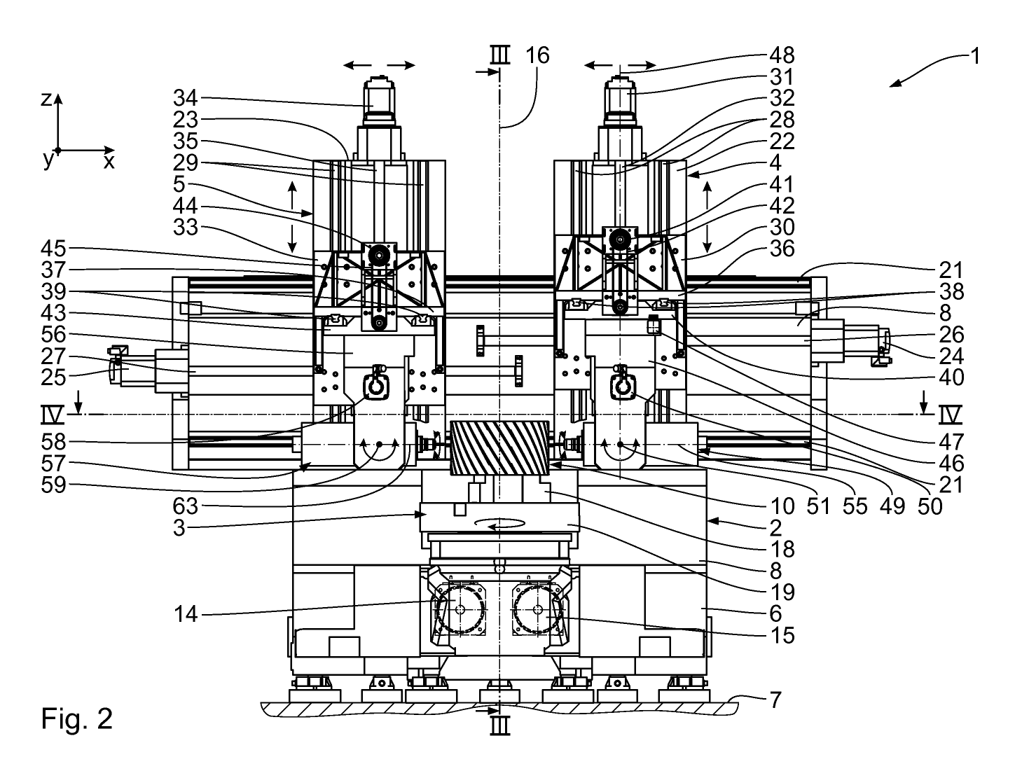

FIG. 3 shows a vertical section through the milling machine in FIG. 2 along the section line III-III, and

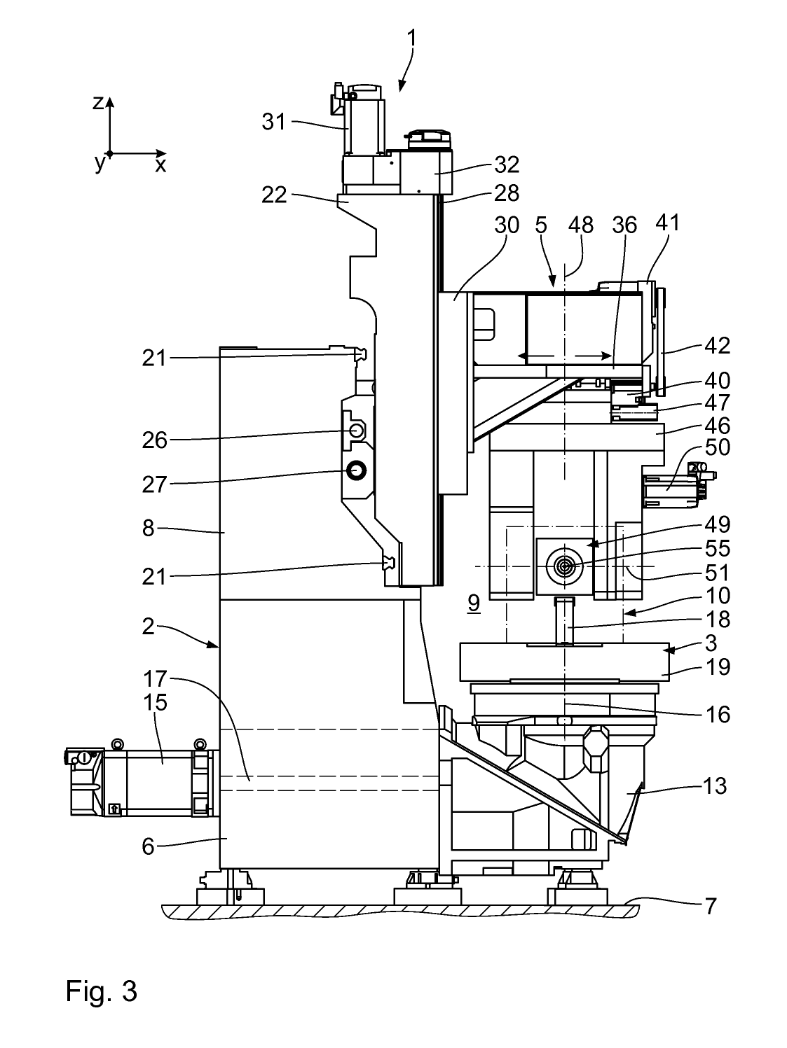

FIG. 4 shows a horizontal section through the milling machine in FIG. 2 along the section line IV-IV.

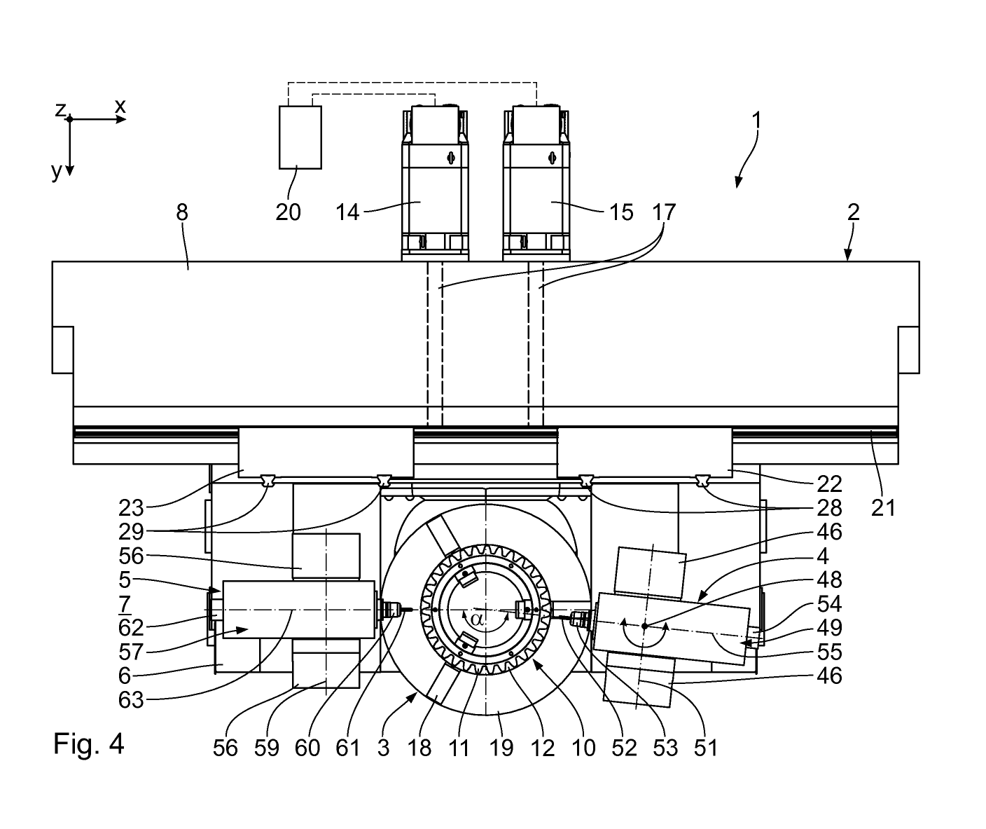

### DESCRIPTION OF THE PREFERRED EMBODIMENT

To produce toothed wheels, a milling machine 1 has a machine frame 2, on which a workpiece receiver 3 and two machining units 4, 5 are arranged.

The milling machine 1 is configured as a vertical turning machine and vertical milling machine. The machine frame 2 is configured in the manner of a stand and substantially has the shape of an L in cross section. A first frame portion 6 extends substantially in a horizontal x-direction and a horizontal y-direction and is fastened to a foundation plate 7. A second frame portion 8, which extends substantially in the horizontal x-direction and a vertical z-direction, is arranged at the end on the first frame portion 6. The frame portions 6, 8 delimit a working space 9, in which workpieces 10 to be toothed are machined to form toothed wheels with teeth 11 and tooth gaps 12 located in between. The x-, y- and z-directions in each case run perpendicular to one another and form a Cartesian coordinate system.

The first frame portion 6, proceeding from the second frame portion 8 tapers in the direction of its free end. A base 13, on which the workpiece receiver 3 is arranged, is fastened centrally on the first frame portion 6 in the x-direction. The workpiece receiver 3 can be pivoted about a workpiece pivot axis 16 by means of two first c-drive motors 14, 15. The workpiece pivot axis 16 runs parallel to the z-direction and will also be called the first c-pivot axis below. The c-drive motors 14, 15 are arranged on a side of the first frame portion 6 remote from the working space 9 and are connected to the workpiece receiver 3 by means of a merely indicated transmission mechanism 17. The workpiece receiver 3 is configured as a rotary table and has a plurality of clamping clamps 18, which, for mounting hollow cylindrical workpieces 10 are arranged on an annular plate 19 and can be displaced radially with respect to the workpiece pivot axis 16. The c-drive motors 14, 15 are operated by means of a control device 20 in the master-slave mode, so the workpiece receiver 3 can be pivoted substantially without play about the workpiece pivot axis 16. The workpiece receiver 3 can preferably be pivoted through 360° about the workpiece pivot axis 16, in other words can be rotated completely about the latter.

Arranged on the second frame portion 8 are x-guide rails 21, which are spaced apart from one another in the z-direction and run parallel to the x-direction. The machining units 4, 5 in each case have an x-slide 22, 23, which is arranged on the x-guide rails 21 and can be moved linearly by means of an associated x-drive motor 24, 25 by means of an x-drive spindle 26, 27 in the x-direction. The x-slides 22, 23 therefore provide two x-linear axes.

Two z-guide rails 28, 29 are in each case arranged on the x-slides 22, 23 and are spaced apart from one another in the x-direction and run parallel to the z-direction. A z-slide 30, which can be move linearly by means of an associated z-drive motor 31 by a z-drive spindle 32 in the z-direction, is arranged on the z-guide rails 28. Accordingly, a z-slide 33, which can be moved linearly by means of a z-drive motor 34 by a z-drive spindle 35 in the z-direction, is arranged on the z-guide rails 29. The z-slides 30, 33 therefore form two z-linear axes.

A support part 36, 37, which projects in the y-direction relative to the associated z-slide 30, 33, is arranged in each case on the z-slides 30, 33. Arranged on the lower side of the respective support part 36, 37 are y-guide rails 38, 39, which are arranged spaced apart from one another in the x-direction and run parallel to the y-direction. Arranged hanging on the y-guide rails 38 is a y-slide 40, which can be moved linearly by means of a y-drive motor 41 by means of a belt drive 42 in the y-direction. Accordingly, a y-slide 43 is arranged hanging on the y-guide rails 39 and can be moved linearly by means of a y-drive motor 44 by a belt drive 45 in the y-direction. The y-drive motors 41, 44 are arranged on an upper side of the respective support frame 36, 37 and can be moved with the respective y-slide 40, 43. The y-slides 40, 43 therefore form two y-linear axes.

Arranged on the y-slide 40 of the first machining unit 4 is a first spindle holder 46, which can be pivoted by means of a second c-drive motor 47 about a first spindle pivot axis 48. The first spindle pivot axis 48 runs parallel to the z-direction and will also be called the second c-pivot axis below. The first spindle pivot axis 48 is spaced apart from the workpiece pivot axis 16 in a radial or horizontal direction. The first spindle pivot axis 48 is unpivotable relative to the workpiece spindle axis 16. The spindle holder 46 is fork-shaped. A first tool spindle 49 is arranged between the fork-shaped ends of the spindle holder 46. The tool spindle 49 can be pivoted by means of a b-drive motor 50 about a second spindle pivot axis 51, which runs horizontally and vertically with respect to the first spindle pivot axis 48. The second spindle pivot axis 51 will also be called the b-pivot axis below, as the latter runs substantially parallel to the y-direction.

To rotatably drive a milling tool 52, the first tool spindle 49 has a first tool receiver 53, which can be rotatably driven about a first spindle rotational axis 55 by means of a first spindle drive motor 54.

The second machining unit 5 has a second fork-shaped spindle holder 56, which, in contrast to the first machining unit 4, is rigidly arranged on the y-slide 43. Thus, the second machining unit 5 has no spindle pivot axis corresponding to the first spindle pivot axis 48. Only the first machining unit 4 has a first spindle pivot axis 48. Arranged between the fork-shaped ends of the spindle holder 56 is a second tool spindle 57, which can be pivoted by means of a second b-drive motor 58 about a second spindle pivot axis 59 running parallel to the y-direction. The second spindle pivot axis 59 will also be called the b-pivot axis below. In accordance with the first tool spindle 49, the second tool spindle 57 has a second tool receiver 60 for a milling tool 61, which can be rotatably driven by means of a second spindle drive motor 62 about a second spindle rotational axis 63. The second spindle rotational axis 63 runs parallel to the x-direction.

The tool spindles 49, 57 can therefore be moved linearly relative to the workpiece receiver 3 in three directions, in each case, namely along their respective x-, y- and z-linear axes. In addition, the two tool spindles 49, 57 can be pivoted about their respective b-pivot axis 51, 59. The b-pivot axes, 51, 59 run perpendicular to the workpiece pivot axis or the first c-pivot axis 16. In addition, the workpiece receiver 3 can be pivoted about the first c-pivot axis 16 and the first tool spindle 49 can be pivoted about the second c-pivot axis 48. The milling machine 1 therefore has a total of six linear axes and four pivot axes. The milling machine 1 has preferably no other linear and/or pivot axes.

To tooth a workpiece 10, the latter is firstly mounted on the workpiece receiver 3. The tool spindles 49, 57 are then pivoted about their b-pivot axes 51, 59 in such a way that the spindle rotational axes 55, 63 run perpendicular to the workpiece pivot axis 16. To produce a tooth system with an uneven number of teeth 11, the first tool spindle 49 is additionally pivoted about the second c-pivot axis 48 so that the spindle rotational axes 55, 63 in the xy-plane enclose an angle α, which does not equal 180°. The angle α to be adjusted is produced from the number of teeth 11. The milling tools 52, 61 are then moved linearly in such a way that they are fed radially to the workpiece 10, with the spindle rotational axis 55 intersecting the workpiece pivot axis 16.

By linearly moving the rotatably driven milling tools 52, 61 and by pivoting the workpiece receiver 3, teeth 11, which run straight or in an oblique manner, with straight or curved tooth flanks, can be produced. By moving the milling tools 52, 61 synchronously, two tooth gaps 12 can be milled simultaneously on the workpiece 10. Owing to the second c-pivot axis 48, this is also possible if the tooth system is to have an uneven number of teeth 11. Since the c-drive motors 14, 15 are operated in the master-slave mode, the workpiece receiver 3 can be substantially pivoted without play about the workpiece pivot axis or first c-pivot axis 16. Since the tool spindles 49, 57 can additionally be pivoted about their b-pivot axes 51, 59, the most varied machining steps, such as grinding, drilling or tapping, milling, rough turning or final turning can take place flexibly. Additionally, an automatic workpiece change can take place by means of the two machining units.

The milling machine 1 therefore has high manufacturing productivity and flexibility and high production precision.

What is claimed is:

1. A milling machine for producing toothed wheels comprising
a machine frame,
a workpiece receiver for receiving a workpiece to be toothed, which workpiece receiver
is arranged on the machine frame, and
is pivotable about a workpiece pivot axis,
a first machining unit for producing a tooth system on the workpiece, wherein
the latter has a first tool spindle to receive a milling tool,
the first tool spindle is movable linearly relative to the workpiece receiver in at least two directions, and
the first tool spindle is pivotable about a first spindle pivot axis, which runs parallel to the workpiece pivot axis,
a second machining unit for producing the tooth system on the workpiece, wherein
the latter has a second tool spindle to receive a milling tool, and
the second tool spindle is movable linearly relative to the workpiece receiver in at least two directions.

2. A milling machine according to claim 1, wherein
the first tool spindle has a first tool receiver for the milling tool, which tool receiver is rotatably drivable by means of a first spindle drive motor about a first spindle rotational axis,
the second tool spindle has a second tool receiver for the milling tool, which tool receiver is rotatably drivable by means of a second spindle drive motor about a second spindle rotational axis, and
the spindle rotational axes, to produce the tooth system, enclose an angle α, which does not equal 180°, wherein the angle α is located in a horizontal plane.

3. A milling machine according to claim 1, wherein
the spindle rotational axes, to produce the tooth system, in each case run perpendicular to the workpiece pivot axis and intersect the workpiece pivot axis, the workpiece pivot axis running in a vertical z direction.

4. A milling machine according to claim 1, wherein
the tool spindles are movable linearly relative to the workpiece receiver in at least three directions, in each case.

5. A milling machine according to claim 1, wherein
at least one of the tool spindles is pivotable about a second spindle pivot axis, which runs perpendicular to the workpiece pivot axis.

6. A milling machine according to claim 1, wherein
each of the tool spindles is pivotable about a second spindle pivot axis, which runs perpendicular to the workpiece pivot axis.

7. A milling machine according to claim 1, wherein
x-guide rails running in a horizontal x-direction are arranged on the machine frame, and
the machining units are movable linearly in the x-direction by means of a respective x-drive motor.

8. A milling machine according to claim 7, wherein
the machine frame is configured in the manner of a stand and the x-guide rails are arranged spaced apart from one another in a vertical z-direction on the machine frame.

9. A milling machine according to claim 7, wherein
each of the machining units comprises:
an x-slide, which is movable on the x-guide rails,
z-guide rails, which are arranged on the x-slide and run in a vertical z-direction, and
a z-slide, which is movable linearly on the z-guide rails by means of a z-drive motor.

10. A milling machine according to claim 9, wherein
each of the machining units comprises:
a support part projecting in a horizontal y-direction and arranged on the z-slide,
y-guide rails running in the y-direction and arranged on the support part, and
a y-slide, which is movable linearly on the y-guide rails by means of a y-drive motor.

11. A milling machine according to claim 10, wherein the y-guide rails are spaced apart from one another in the x-direction and the respective y-slide is arranged hanging on the associated support part.

12. A milling machine according to claim 10, wherein
the tool spindles are arranged on the respective y-slide and the spindle rotational axis of the second tool spindle is arranged parallel to the x-direction.

13. A milling machine according to claim 10, wherein
at least one of the tool spindles is arranged by means of a spindle holder on the associated y-slide, the at least one tool spindle being pivotable by means of a b-drive motor about the second spindle pivot axis.

14. A milling machine according to claim 9, wherein
each of the tool spindles is arranged by means of a spindle holder on the associated y-slide, the at least one tool spindle being pivotable by means of a b-drive motor about the second spindle pivot axis.

15. A milling machine according to claim 10, wherein
the first tool spindle is arranged on the associated y-slide so as to be pivotable by means of a c-drive motor about the first spindle pivot axis.

16. A milling machine according to claim 14, wherein
the workpiece receiver is pivotable without play about the workpiece pivot axis by means of two c-drive motors.

17. A milling machine according to claim 1, wherein
the first spindle pivot axis runs spaced apart from the workpiece pivot axis.
